(19) United States
(12) Patent Application Publication
(10) Pub. No.: US 2010/0224642 A1
(43) Pub. Date: Sep. 9, 2010

(54) SYSTEM, METHOD AND APPARATUS FOR ROTATABLE DISPLAY AND SERVER ENSEMBLE HAVING RECONFIGURABLE AND INTERCHANGEABLE COMPONENTS

(75) Inventors: Juanita Jean Beeson, Grand Haven, MI (US); Kimberlee Sue Beeson, Grand Haven, MI (US); Roy Paul Prosise, Cedar Park, TX (US)

Correspondence Address: LARSON NEWMAN & ABEL, LLP, 5914 WEST COURTYARD DRIVE, SUITE 200, AUSTIN, TX, 78730, US

(73) Assignee: BEE SERVED, Grand Haven, MI (US)

(21) Appl. No.: 12/715,924

(22) Filed: Mar. 2, 2010

Related U.S. Application Data
(60) Provisional application No. 61/209,078, filed on Mar. 3, 2009.

(51) Int. Cl. B65D 25/00; A47G 23/08; F16M 13/00

(52) U.S. Cl. 220/737; 248/349.1; 248/346.03

(57) ABSTRACT

A rotatable centerpiece provides a decorative element for displaying and serving food items on a dining table with reconfigurable and interchangeable components. The centerpiece provides connectable containers for food, condiments, nuts and the like, and decorative items such as flowers, arrangements or fish in water. A base assembly includes a turntable and a platter or bowl. The platter or bowl is removably engaged with the turntable. The base assembly supports other upper components, such as a bud stem or vase, a globe, a brandy snifter, a pillow disk and/or a dip bowl, which may be arrayed in numerous interlocking configurations.

This application claims priority to and the benefit of U.S. Provisional Patent Application No. 61/209,078, filed on Mar. 3, 2009, which is incorporated herein by reference in its entirety.

### FIELD OF THE DISCLOSURE

This invention generally relates to food display and service equipment and, in particular, to a rotatable food display and server ensemble having interchangeable and reconfigurable components, and combining food with an artistic arrangement or related art.

### DESCRIPTION OF THE RELATED ART

Rotary food display and service devices or ‘lazy susans’ typically comprise a circular platform that rotates about a central axis. A variety of foods or condiments are positioned on the upper surface of the platform. The device is commonly positioned in the center of a dining table and rotated by the people seated at the table to provide easier access to the items located thereon. Although some conventional designs have removable trays for holding a variety of foods, such rotating table display devices are typically of singular or limited application.

For example, U.S. Pub. No. 2002/0162490, to Petryna, discloses a modular rotatable food tray supported by a vertical support member features tray segments that are removable and free standing. Each tray segment has a depending clip that is received in a hub of a bearing for rotatably supporting the tray. The individual tray segments may be removed for filling and cleaning, and segments of a different configuration can be used for other purposes.

U.S. Pat. No. 7,225,633, to DeMars, describes a rotary food server for storing food in a chilled condition. This design includes a dish rotatably mounted on a stationary base and has central and peripheral pockets for removably receiving food storage trays having removable lids.

U.S. Pat. No. 4,060,038, to Ruvolo, discloses a dining room table to facilitate serving food including inner, intermediate and outer concentric sections. The intermediate section is rotatably mounted on a pedestal to pass food around a table.

U.S. Pat. No. 7,124,694, to Li, describes an umbrella table with an inlaid turntable. The table includes a tabletop having a substantially planar top surface with a circular aperture therein.

U.S. Pat. No. 3,980,027, to Maes, provides a display table for simultaneously displaying various kinds of ornamental objects, particularly objects that are designed to decorate a table. The display table comprises a circular central panel, an outer panel concentric with and mounted for rotation about the central panel, and a storage space situated under the outer panel.

U.S. Pat. No. 4,036,151, to Shin, describes a microwave cooking apparatus having a turntable for rotating foodstuffs within an oven cavity to effect uniform heating. The turntable couples with or separates from a power transmission system including a power source. The turntable is utilized as a foodstuff shelf within the oven cavity when it is associated with the power transmission system. It also is utilized as a cooking tray when it is removed from the power transmission system and disposed directly on a dining table.

U.S. Pat. No. 6,186,055, also to DeMars, describes a turntable cooking and serving appliance that utilizes a planer base within which is a centrally mounted pan. The pan includes an electrically-operated heating element. A cooking vessel is removably locatable within the pan. An annular compartment surrounds the pan. A ring is mounted within the annular compartment with a bearing assembly located between the ring and the floor of the annular compartment. A plurality of trays is locatable within the annular compartment and is adapted to rest on the ring and to be rotatable therewith. Each tray contains food that may be cooked within the cooking vessel.

Finally, U.S. Pat. No. 5,894,943, to Liu, describes a turntable assembly comprising a supporting base and an oven fixed to the top of the supporting base. A rotational disk can be rotationally and movably supported between the oven and the supporting base. The rotational disk is above the surface of the table without touching the dishes or bowls disposed on the table. By this arrangement, a plurality of courses can be simultaneously supported. Although each of these conventional designs is workable for displaying and/or serving food, an improved and more versatile design would be desirable.

### SUMMARY OF THE INVENTION

Embodiments of a system, method and apparatus for a rotary turntable ensemble with reconfigurable, interchangeable components for a table top display are disclosed. Reconfigurable components contain and display a variety of food service items and condiment dispensing and decoration displays. Embodiments of these components may be combined with a vertical support member that may be engaged with different containers to provide significant advantages over the prior art.

Embodiments of a rotating table centerpiece provide a decorative element for a dining table with reconfigurable and interchangeable components. The centerpiece provides containers for food, condiments, nuts and the like, and/or decorative items such as flowers, arrangements or fish in water. Embodiments may comprise a base assembly and upper components. The base assembly includes a turntable comprising a thrust bearing engaged with a base component, such as a platter or bowl, which retains the components on it. The platter or bowl is removably engaged with the turntable allowing for enabling either a platter or bowl configuration for the base assembly. The base assembly rigidly supports the upper components, which may include but are not limited to a stem, a globe, a brandy snifter, a pillow disk and a dip bowl.

In some embodiments, one or more of the upper components are engaged with and secured directly to the base component. In another configuration, a vertical support member or stem is mounted to the base, and then an upper component is engaged with and rigidly mounted to the vertical support member. The components may be combined in alternate configurations to form an array of rigidly stacked components that are readily and easily disassembled after use.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention are attained and can be understood in more detail, a more particular description of the invention briefly summarized above may be had by reference to the embodiments thereof that are illustrated in the appended drawings. However, the drawings illustrate only some embodiments of the invention and therefore are not to be considered limiting of its scope as the invention may admit to other equally effective embodiments.

FIG. 1A is an exploded isometric view of an embodiment of a turntable, platter and bowl constructed in accordance with the invention;

FIG. 1B is an exploded isometric view of an embodiment of the platter and turntable constructed in accordance with the invention;

FIG. 1C is an isometric view of an embodiment of an assembly of the platter, bowl and turntable, and is constructed in accordance with the invention;

FIGS. 2A, 2B and 2C are isometric views of embodiments of a base configuration engaged with various upper components, and are constructed in accordance with the invention;

FIGS. 3A, 3B and 3C are isometric views of embodiments of various components engaged with a stem and base, and are constructed in accordance with the invention;

FIG. 4 is a sectional side view of an embodiment of an ensemble of components constructed in accordance with the invention;

FIG. 5 is an enlarged, partially sectioned, isometric view of an alternate embodiment of an engagement mechanism for joining elements, shown in an unengaged or unlocked position, and is constructed in accordance with the invention;

FIG. 6 is an enlarged, partially sectioned, isometric view of the alternate embodiment of the engagement mechanism of FIG. 5, shown in an engaged or locked position, and is constructed in accordance with the invention; and

FIG. 7 is a sectional side view of the engagement mechanism, taken along line 7-7 of FIG. 6, and is constructed in accordance with the invention.

The use of the same reference symbols in different drawings indicates similar or identical items.

### DETAILED DESCRIPTION

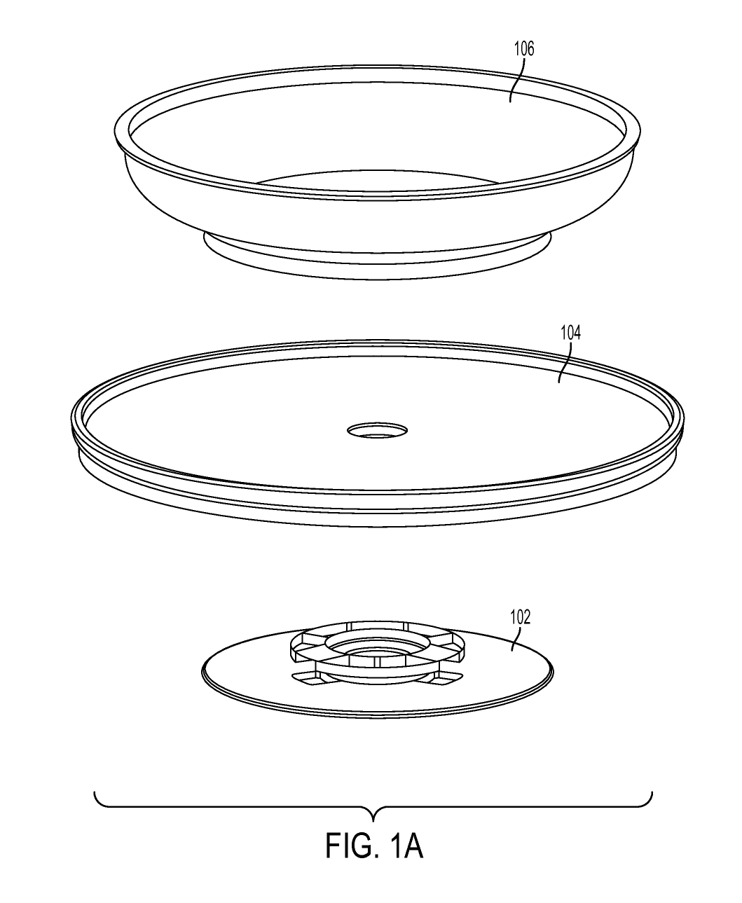

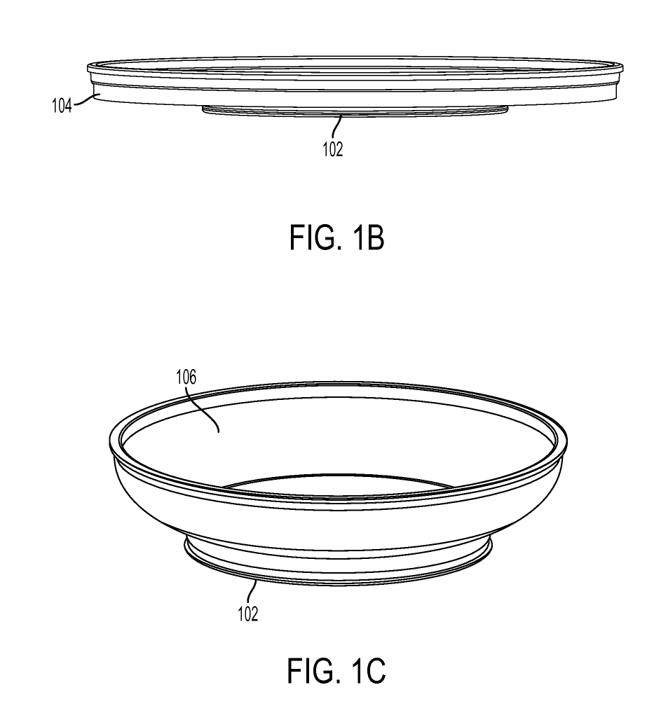

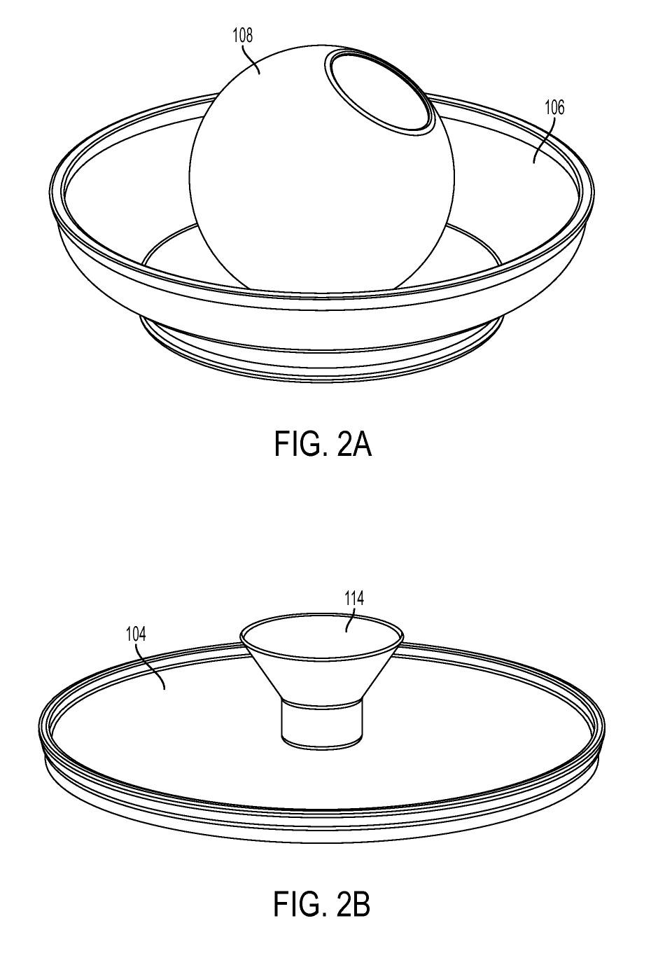

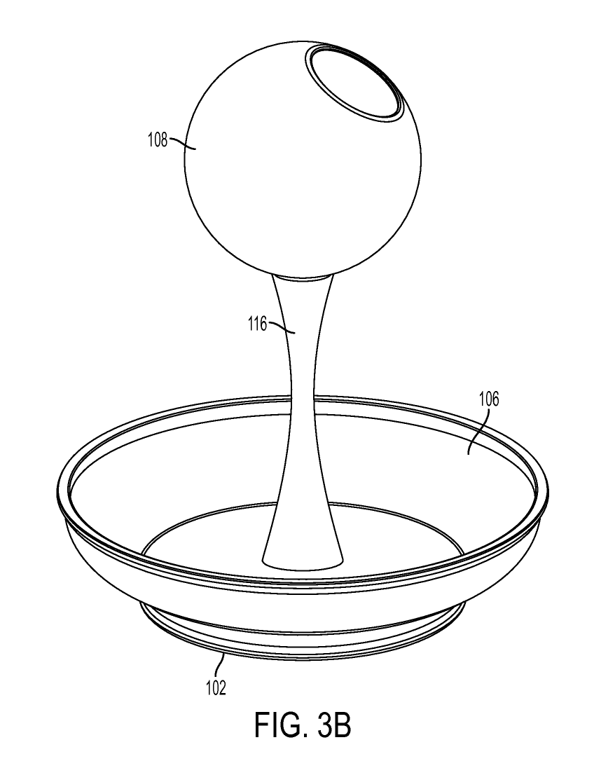

Embodiments of a system, method and apparatus for a rotary turntable serving ensemble with interchangeable components for a table top display are disclosed in FIGS. 1 through 7. FIG. 1A illustrates an embodiment of a rotatable turntable 102. As shown in FIG. 4, the turntable 102 may comprise has a stationary foundation 103 and a thrust bearing 105 that rotates about a central axis 107 relative to the foundation 103. As will be described herein, turntable 102 enables rotary motion of other elements that are assembled to it relative to an underlying support surface, such as a table 109.

For example, the turntable 102 may be removably engaged with a base component, such as either a platter 104 (FIG. 1B) or a bowl 106 (FIG. 1C). In some embodiments, the turntable 102 rigidly mounts to the base component 104, 106 to provide a stable rotatable platform, or (collectively) a base assembly 111 (FIG. 4), for displaying and serving food items. In other embodiments, the base component merely rests on the turntable and is retained there only by gravity. The turntable and base component are readily disassembled after use. These configurations form various embodiments of base assemblies that may be further built upon with other components as will be described herein.

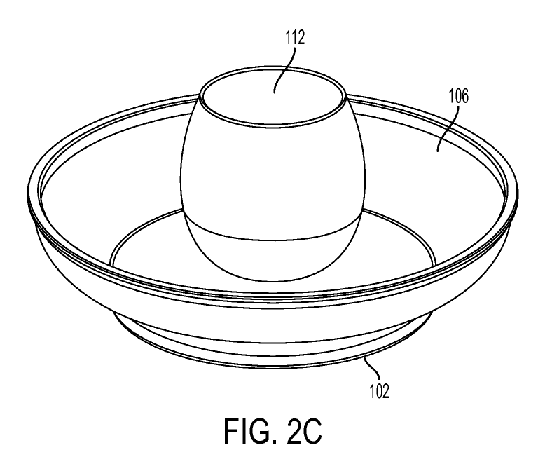

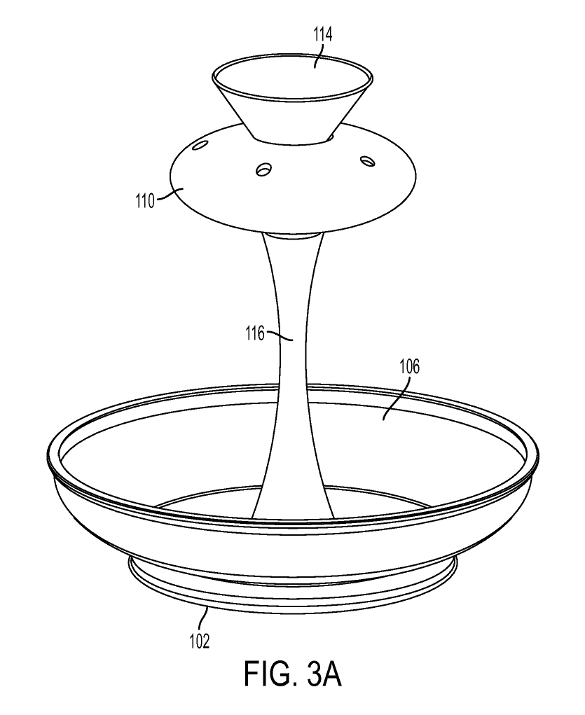

The base assembly may be removably engaged with at least one of, or a combination of, upper components for food display and service. For example, the upper components may include but are not limited to a globe 108 (FIG. 2A), a pillow top or pillow disk 110 (FIG. 3A), a brandy snifter 112 (FIG. 2C), a dip bowl 114 (FIG. 2B), and a stem and bud vase 116 (FIGS. 3A, 3B and 3C). Other optional components include a wine goblet, a martini-shaped bowl, etc. Any single upper component or combination of upper components may be engaged with and/or positioned on either of the base configurations.

FIGS. 2A, 2B and 2C illustrate various embodiments, including either base configuration, with individual upper components. FIGS. 3A, 3B and 3C illustrate various embodiments including the vertical support member or stem 116 engaged with different combinations of upper components. The stem 116 may be configured alone as a hollow bud vase 119 for supporting a displaying one or more flowers (see, e.g., phantom flower 117 in FIG. 4), or used in combination with other components that are securely and rigidly but releasably mounted to its upper end.

In some embodiments, the user selects either the platter 104 or the bowl 106 and engages it with the turntable 102. As best shown in FIG. 4, the turntable 102 is removably engaged with either the bowl 106 or the platter 104 by means of upper and lower engagement devices 121, 123. For example, the upper and lower engagement devices may comprise snap fit interlocking components, threaded male and female features, magnets, combinations thereof, or other secure but selectively removable engagement devices that form a rigid, stable connection between the elements that is also readily releasable.

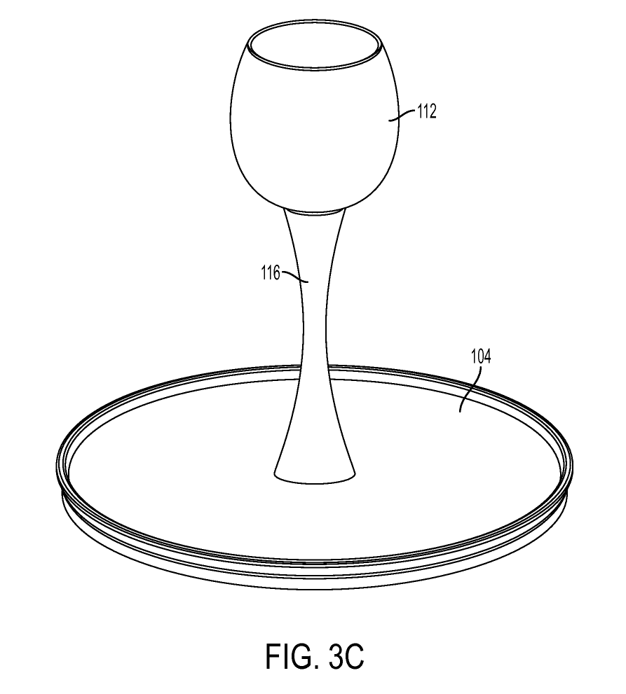

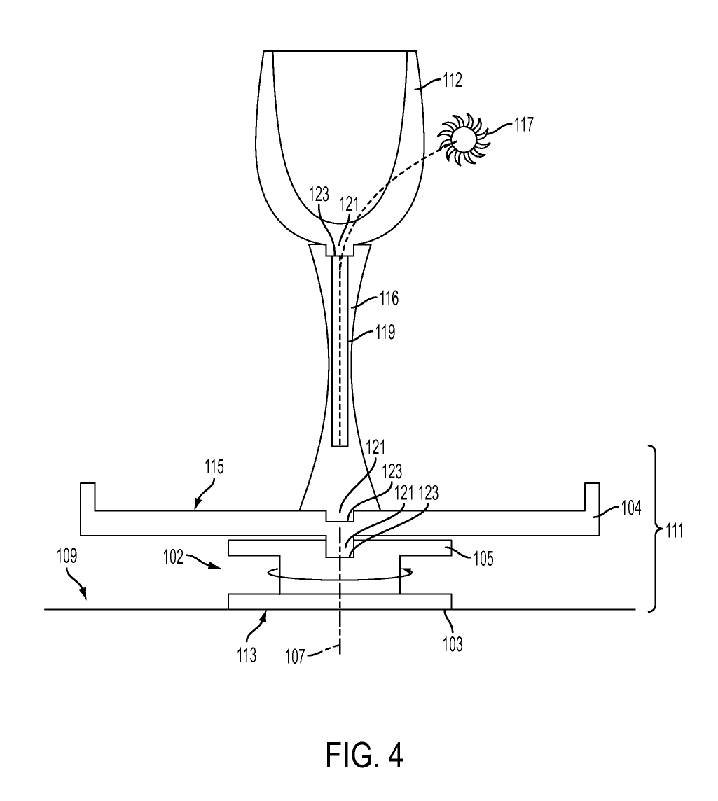

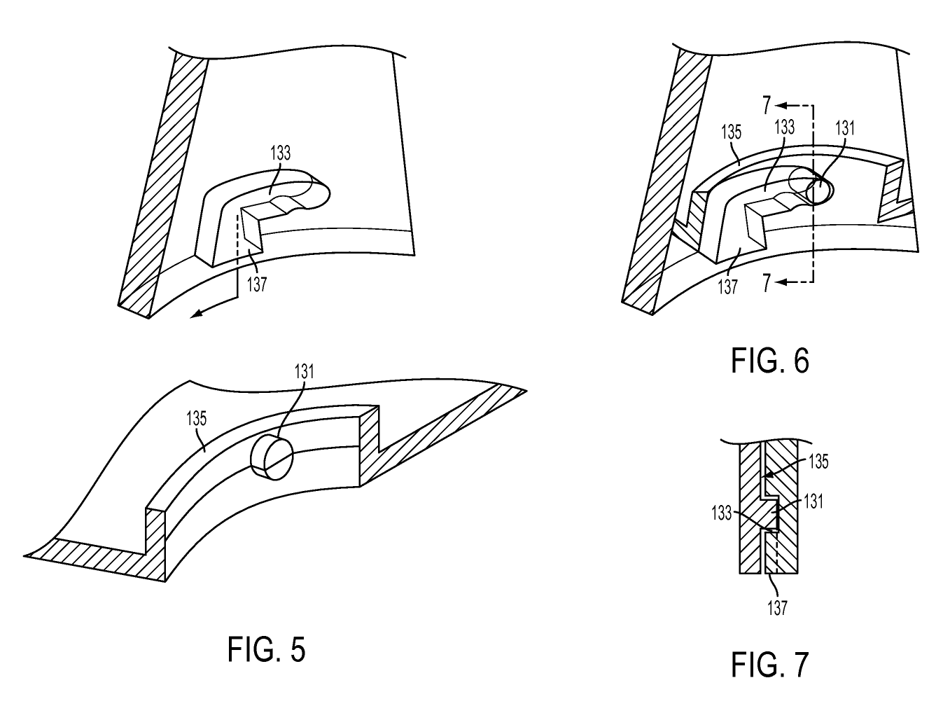

Referring now to FIGS. 5-7, another embodiment of upper and lower engagement devices comprise a key 131 and socket 133. For example, in the illustrated embodiment, key 131 is provided on an interior surface wall of one element (e.g., the turntable, the base component or the upper component), and the slotted socket 133 is complementarily formed as a keyway spline in the joining element. FIG. 5 depicts the unengaged or unlocked position. To join the elements, the key 131 on one element is rotationally aligned (FIG. 5) with an entry hole 137 in the other element, axially inserted, and then rotated (e.g., approximately 5 to 15 degrees) to the engaged or locked position (FIGS. 6 and 7), to form a positive mechanical interlock between the elements. These steps are reversed to disengage or unlock the elements.

Accordingly, the components are not merely stacked, nested or resting on each other unattached; rather, they are physically engaged and mounted to each other to provide a rigid usable, rotatable support and display of food and condiment items. The components will not separate without manual intervention to selectively disengage them after use. The upper components are combined and/or engaged with the base assembly and mechanically joined to each other. However, they are removably engaged in a manner that eliminates unintended relative motion between the engaged and retained elements. Individual elements or combinations of the upper components are assembled onto the base in a variety of reconfigurable embodiments.

In some embodiments, each of the components may be formed from a clear, high quality acrylic material that may be provided with frosted accents. Transparent and opaque colors also may be used, as well as glass, ceramic or other materials.

In other embodiments, a system for food display and service comprises a base assembly 111 (FIG. 4) comprising a rotatable turntable 102 and one of the base components 104, 106 mounted thereto to form the base assembly 111. The rotatable turntable 102 has a lower surface 113 adapted to be supported by an underlying support surface (e.g., table 109). The base component has an upper surface 115 with an upper engagement feature 121. One or more of a plurality of upper components are joined to the base component. Each upper component has a lower engagement feature 123 for engaging the upper engagement feature 121, such that each of the upper components may be rigidly secured to and selectively retained on the base assembly 111. The upper components are interchangeable and reconfigurable with the base component and with each other. The rotatable turntable 102 facilitates rotation of the base component and the upper components relative to the underlying support surface 109.

Embodiments of the base component are rigidly but removably mounted to the turntable. The rotatable turntable may comprise a thrust bearing 105, and the base component may comprise one of a platter 104 and a bowl 106. Some of the upper components (e.g., stem 116) may further comprise a second upper engagement feature 123 for engaging the lower engagement feature 121 on another one of the upper components (e.g., brandy snifter 112). In this way, a plurality of the upper components may be secured to and selectively retained on each other in a stacked configuration as shown in the drawings.

In other embodiments, one of the upper components is a vertical member 116 on which may be mounted other ones of the upper components. The vertical member may comprise a bud vase having a hollow chamber 119 adapted to support and display a flower 117. The bud vase has a second upper engagement feature 123 for engaging the lower engagement feature 121 on another one of the upper components, such that said another one of the upper components may be secured to and selectively retained on the bud vase in a stacked configuration.

The upper and lower engagement features may comprise one of snap fit features, threaded features, magnets, and a key and slotted socket, to form a rigid and stable connection between the base assembly and the upper components. The base assembly and the upper components are removably engaged to eliminate unintended relative motion therebetween.

This written description uses examples to disclose the invention, including the best mode, and also to enable those of ordinary skill in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for food display and service, comprising:
a base assembly having a lower surface adapted to be supported by an underlying support surface, and an upper surface having an upper engagement feature; and
a plurality of components, each having a lower engagement feature for engaging the upper engagement feature such that each of the components may be secured to and selectively retained on the base assembly.

2. A system according to claim 1, wherein the components are interchangeable and reconfigurable with the base assembly.

3. A system according to claim 1, wherein the base assembly comprises one of a platter and a bowl.

4. A system according to claim 3, wherein the base assembly comprises a rotary turntable for facilitating rotation of the platter or bowl and components relative to the underlying support surface.

5. A system according to claim 4, wherein the platter or bowl is rigidly but removably mounted to the turntable.

6. A system according to claim 1, wherein some of the components further comprise a second upper engagement feature for engaging the lower engagement feature on another one of the components such that a plurality of the components may be secured to and selectively retained to each other in a stacked configuration.

7. A system according to claim 1, wherein the base assembly comprises a thrust bearing.

8. A system according to claim 1, wherein one of the components comprises a vertical member on which may be mounted other ones of the components.

9. A system according to claim 8, wherein the vertical member is a bud vase having a hollow chamber adapted to support and display a flower, and comprises a second upper engagement feature for engaging the lower engagement feature on another one of the components such that said another one of the components may be secured to and selectively retained on the bud vase in a stacked configuration.

10. A system according to claim 1, wherein the components comprise a globe, a pillow disk, a brandy snifter, a dip bowl, and a stem.

11. A system according to claim 1, wherein the upper and lower engagement features comprise one of snap fit features, magnets, and a key and slotted socket, to form a rigid and stable connection between the base assembly and components, such that the base assembly and components are removably engaged to eliminate unintended relative motion therebetween.

12. A system for food display and service, comprising:
a base assembly comprising a rotatable turntable and a base component mounted thereto to form a base assembly, the rotatable turntable having a lower surface adapted to be supported by an underlying support surface, and the base component having an upper surface with an upper engagement feature;
a plurality of upper components, each having a lower engagement feature for engaging the upper engagement feature such that each of the upper components may be rigidly secured to and selectively retained on the base assembly, the upper components being interchangeable and reconfigurable with the base component; and
the rotatable turntable facilitates rotation of the base component and the upper components relative to the underlying support surface.

13. A system according to claim 12, wherein the base component is rigidly but removably mounted to the turntable.

14. A system according to claim 12, wherein the rotatable turntable comprises a thrust bearing, the base component comprises one of a platter and a bowl, and the upper components comprise a globe, a pillow disk, a brandy snifter, a dip bowl, and a stem.

15. A system according to claim 12, wherein some of the upper components further comprise a second upper engagement feature for engaging the lower engagement feature on another one of the upper components such that a plurality of the upper components may be secured to and selectively retained on each other in a stacked configuration.

16. A system according to claim 12, wherein one of the upper components is a vertical member on which may be mounted other ones of the upper components, the vertical member comprising a bud vase having a hollow chamber adapted to support and display a flower, the bud vase having a second upper engagement feature for engaging the lower engagement feature on another one of the upper components such that said another one of the upper components may be secured to and selectively retained on the bud vase in a stacked configuration.

17. A system according to claim 12, wherein the upper and lower engagement features comprise one of snap fit features, magnets, and a key and slotted socket, to form a rigid and stable connection between the base assembly and the upper components, such that the base assembly and the upper components are removably engaged to eliminate unintended relative motion therebetween.

18. A food display and service ensemble, comprising:
a base assembly comprising a rotatable turntable and a base component mounted thereto to form a base assembly, the rotatable turntable having a lower surface adapted to be supported by an underlying support surface, and the base component having an upper surface with an upper engagement feature, and the base component is rigidly but removably mounted to the turntable;
a plurality of upper components, each having a lower engagement feature for engaging the upper engagement feature such that each of the upper components may be rigidly secured to and selectively retained on the base assembly, the upper components being interchangeable and reconfigurable with the base component;
at least one of the upper components further comprises a second upper engagement feature for engaging the lower engagement feature on another one of the upper components such that a plurality of the upper components may be secured to and selectively retained on each other in a stacked configuration;
the rotatable turntable facilitates rotation of the base component and the upper components relative to the underlying support surface; and
the upper and lower engagement features comprise one of snap fit features, magnets, and a key and slotted socket, to form a rigid and stable connection between the base assembly and the upper components, such that the base assembly and the upper components are removably engaged to eliminate unintended relative motion therebetween.

19. A food display and service ensemble according to claim 18, wherein the rotatable turntable comprises a thrust bearing, the base component comprises one of a platter and a bowl, and the upper components comprise a globe, a pillow disk, a brandy snifter, a dip bowl, and a stem.

20. A food display and service ensemble according to claim 18, wherein one of the upper components is a vertical member on which may be mounted other ones of the upper components, the vertical member comprising a bud vase having a hollow chamber adapted to support and display a flower, the bud vase having the second upper engagement feature for engaging the lower engagement feature on another one of the upper components such that said another one of the upper components may be secured to and selectively retained on the bud vase in the stacked configuration.
